(19) United States
(12) Patent Application Publication
(10) Pub. No.: US 2008/0210831 A1
(43) Pub. Date: Sep. 4, 2008

(54) STAND

(76) Inventor: Gary Considine, Woodland Hills, CA (US)

Correspondence Address: HOLLAND & HART, LLP, P.O BOX 8749, DENVER, CO, 80201, US

(21) Appl. No.: 11/969,807

(22) Filed: Jan. 4, 2008

Related U.S. Application Data
(60) Provisional application No. 60/878,734, filed on Jan. 4, 2007.
(60) Provisional application No. 60/878,374, filed on Jan. 4, 2007.

(51) Int. Cl. F16M 11/08

(52) U.S. Cl. 248/125.1; 248/188; 73/12.09

(57) ABSTRACT

A system is provided for supporting one or more objects above an operating surface. A central frame extends upwardly from a base and supports one or more attachment members for supporting a variety of objects. In one aspect the objects supported by the system are targets that receive striking forces from external sources. A force measuring device may be associated with the targets. The central frame may be adjustable so that the height of the objects supported by the system may be varied. The base may include stabilizer members that are movable between collapsed and extended positions. Weight of various types may be associated with the stabilizer members to promote stability of the system. Wheels may be associated with the base to enable transport of the system from one location to another.

### CROSS-REFERENCE TO RELATED PATENT APPLICATIONS

The invention claims priority from U.S. Provisional Patent Application No. 60/878,734 entitled STAND by Gary Considine, Rita Sever, Jeff Dankworth, Greg Snyder, and Patricia Brenner, filed on Jan. 4, 2007, which Provisional Patent Application is hereby incorporated by reference in its entirety.

### OTHER RELATED PATENTS

U.S. Pat. No. 7,308,818 (the '818 patent), entitled “Impact-Sensing and Measurement Systems, Methods for Using Same, and Related Business Methods,” issued on Dec. 18, 2007, is hereby incorporated by reference herein in its entirety. U.S. patent application Ser. No. 12/004,337 (the '337 patent Application), entitled “Impact-Sensing and Measurement Systems, Methods for Using Same, and Related Business Methods,” filed on Dec. 18, 2007, is hereby incorporated by reference herein in its entirety.

In the event of a conflict, the subject matter explicitly recited or shown herein controls over any subject matter incorporated by reference. All definitions of a term (express or implied) contained in any of the subject matter incorporated by reference herein are hereby disclaimed only to the extent that such definitions are inconsistent with or narrower than the understanding of the term as used herein. The paragraphs shortly before the claims dictate the meaning to be given to any term explicitly recited herein subject to the disclaimer in the preceding sentence.

### BACKGROUND

Sports stands for receiving impacts associated with sporting activities, such as martial arts, boxing, soccer, football, baseball, golf, tennis, etc., are known in the art. Typically, sports stands support targets or nets that receive impacts from a user's body or objects, such as balls, hit or thrown by a user. Generally, sports stands are configured to resist such impacts, i.e., absorb the force of the impacts, without damage to or inadvertent repositioning, or movement, of the stands and to allow their continued use.

Conventional sports stands for receiving impacts associated with athletic workouts, such as martial arts workouts, can be bulky and heavy. Accordingly, these stands are often difficult to store, transport and reposition.

For example, conventional stands can include large containers filled with water or sand to create a heavy base for resisting movement of the targets upon receiving an impact. Such targets can weigh upwards of approximately 200 lbs., which can make the stands difficult to move and adjust.

Some conventional stands require often complex disassembly prior to storing or moving the stands.

Additionally, many conventional sporting stands require a permanent installation. For example, some known stands must be bolted to a secure surface, such as the floor or a wall, in order to prevent the stand from moving.

Also, with many known sporting stands, customization of the stands to accommodate different sports and athletic workouts can be difficult. For example, many known sports stands are configured to receive impacts associated with one specific sporting activity and cannot be modified for use with other sporting activities.

### SUMMARY

This Summary is provided to introduce a variety of concepts in a simplified form and that are further described below in the Detailed Description. This Summary, and the foregoing Background, is not intended to identify key aspects or essential aspects of the claimed subject matter or all embodiments thereof. Moreover, this Summary is not intended for use as an aid in determining the scope of the claimed subject matter.

A stand is provided to support objects above an operating surface and generally includes a collapsible base portion, a central frame member that extends from the base, and one or more attachment members. In one aspect, the base portion is provided to be selectively moved between a collapsed state and an expanded state. In some embodiments, the base portion includes a plurality of elongate stabilizer members that engage the operating surface in their respective extended positions. In one aspect, the stabilizer members are pivotally coupled to a bottom end portion of the central frame member at first end portions. Connector arms are pivotally coupled to the stabilizer members and the central frame member to permit the movement of the stabilizer arms between their collapsed and extended positions

Second end portions of the connector arms may be coupled to the central frame member via a movable bracket that is movable along the central member. The movable bracket may include a locking mechanism that is engageable with the central member to lock the movable bracket in place relative to the central member.

The base portion may be placed in an open, or expanded, state by locking the bracket, at a location along the central member such that the stabilizer members extend generally perpendicularly relative to the central member and each other.

The base portion may also include a height adjustment member that is movable relative to the central member. The height adjustment member may be aligned with the central member to extend vertically away from the central member. In this manner, the height adjustment member can extend linearly away from or toward the central member in a telescoping manner to increase or decrease the overall height of the base portion.

The central frame member may be provided to include a locking mechanism proximate its upper end portion. In at least one embodiment, the locking mechanism may be provided to include a spring-loaded pin that is sized to extend through spaced-apart apertures in the central member. The locking mechanism of the central member may also include a knob coupled to the pin to facilitate locking and unlocking the height adjustment member relative to the central member.

In one aspect, the stand may include weight mounts that each have a generally U-shaped base defining a channel for receiving a respective stabilizer member. An elongate weight securing member may be provided to extend from the base. The weight mounts can be removably positioned about the stabilizer members such that the weight securing members extend transversely relative to the stabilizer members in a vertical direction. The weight securing members are configured to receive one or more conventional gymnasium weight disks, which act as anchors to keep the stand.

The accessory receiving portion may be provided as a generally tubular member extending substantially perpendicularly from the base portion. The accessory receiving portion may define an interior channel that may be sized to receive a portion of an accessory, such as a target. The accessory receiving portion can include a slot that extends from an open end, opposite the base portion, and a clamp mechanism that extends about the accessory receiving portion proximate the open end. The cross-sectional area of the channel may then be reduced by tightening the clamp mechanism into a locked position which reduces the width of the slot.

The accessory may be provided with an attachment member, having the same general cross-sectional shape as the channel of the accessory receiving portion and a cross-sectional area that is slightly smaller than the same channel. The attachment member of the accessory may be inserted into the channel of the accessory receiving portion when the clamp mechanism is in an unlocked position. With the attachment member of the accessory positioned within the channel and the clamp mechanism in an unlocked state, the accessory can be rotated 360-degrees relative to the accessory receiving portion. The clamp can be loosened to remove the accessory or reposition the accessory to a different angle. In one aspect a spring may be associated with the attachment member and disposed between the target and the accessory receiving portion. Accordingly, a measured, multi-axis resiliency is provided to the connection of the target to the stand that allows the target to be struck by a user while permitting the target to return to its original position.

In one aspect, the target, or hitting pad, may be provided to include a padded striking surface on opposing sides of an at least partially rigid frame. The target may further include an impact sensor, such as described in U.S. Pat. No. 7,308,818, which is incorporated herein by reference. The impact sensor can be secured to the frame such that it is covered by the padded striking surface.

In some embodiments, the stand may support two or more targets removably and adjustably coupled to an accessory extension member. The accessory extension member may be provided to include an attachment member removably securable within an accessory receiving portion of a primary connector. In some embodiments, the extension member may be provided to rotate about the accessory receiving portion 360-degrees to place the extension member in any of various positions depending on the particular application.

In some embodiments, the stand may further include first and second secondary connectors removably and adjustably coupleable to the accessory extension member. The first and second secondary connectors may be removably securable to the extension member via various locking mechanisms and positionable at any of various locations along the extension member. Each target may be provided to be removably securable to a respective one of the first and second secondary connectors. Each target may also be provided in a manner that permits each target to be rotated to a particular angle irrespective of the angle of the other target.

In some embodiments, the stand may be provided with a different accessory, such as a net accessory. The net accessory may be provided to include an attachment member that is removably securable to a connector. A net hanger may be provided to be coupled with the attachment member and a net may be secured to and depend from the net hanger. The net accessory may also include an impact surface, such as a pad, to which an impact sensor is secured. The impact sensor may be electrically coupled to an impact sensing module, such as impact-sensing module.

In some embodiments, the stand may be provided in a heavier and more durable fashion for commercial applications and sports uses. The base portion may include an elongate central member and elongate stabilizer members. Connector plates are coupled to a bottom end portion of the central member and a base plate along side and bottom edge portions of the connector plates. The stabilizer members are coupled to the connector plates at first end portions, respectively, such that the stabilizer members can pivot about their first end portions relative to the central member.

A stabilizer member may be associated with the stand in a spaced-apart relationship with the stabilizer members. In one aspect, a connector bracket may be coupled with the central member. A first end portion of the stabilizer member may be pivotably coupled with the connector bracket to permit the stabilizer member to move between collapsed and extended states. A retaining pin may be engaged with apertures formed adjacent upper and lower end portions of the connector plates to secure the stabilizer member in its respective collapsed and expanded states.

In certain embodiments, the stability of the stand may be further promoted by engaging relatively high friction pads at the distal end portions of the stabilizer members. It is contemplated that the high friction pads may be provided in the form of foot members formed from various materials, including generally resilient materials that include natural and synthetic rubbers as well as some polymer materials. An additional friction pad may be placed on a bottom surface of the base plate for additional stability. The friction pads may further limit the transmission of vibrations from the stand to the operating surface, which may tend to reduce noise emitted from use of the stand, and may further limit damage to the operating surface.

There or other aspects of this disclosure and varying embodiments. They will be apparent as this specification proceeds.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a perspective view of one embodiment of the stand in a collapsed and partially disassembled position.

FIG. 2 is a front elevation view of the stand depicted in FIG. 1 and further demonstrates one contemplated assembly position of the stand base.

FIG. 3 depicts a front elevation view of an upper end portion of the stand depicted in FIG. 2 and one contemplated embodiment of a height adjustment system that may be incorporated with the stand.

FIG. 4 depicts a front elevation view of an upper end portion of the stand depicted in FIG. 2 and contemplated embodiments of a target and an impact sensing system that may be incorporated with the stand.

FIG. 5 depicts a perspective view of an upper end portion of the stand depicted in FIG. 2 and one contemplated embodiment of a height adjustment system that may be incorporated with the stand.

FIG. 6 depicts a side elevation view of an upper end portion of the stand depicted in FIG. 2 and one contemplated embodiment of an accessory extension member that may be incorporated with the stand.

FIG. 7 depicts a front perspective view of one embodiment of the stand and one manner in which it may be used to support one embodiment of a net accessory.

FIG. 8 depicts a front elevation view of another embodiment of the stand in a collapsed position.

FIG. 9 depicts a rear, plan view of an alternate embodiment of a base that may be used with the stand, with its stabilizer members in a collapsed position.

FIG. 10 depicts an isometric view of the base depicted in FIG. 20, with its stabilizer members in an extended position.

FIG. 11 depicts a side elevation view of the base depicted in FIG. 20, with its stabilizer members in an extended position.

FIG. 12 depicts a perspective view of a target that may be operatively coupled with the stand in a generally horizontal manner.

FIG. 13 depicts a multi-target arm, simultaneously supporting a plurality of targets, that may be supported by the stand.

FIG. 14 depicts a perspective view of a secondary target that may be operatively coupled with the stand in a generally horizontal manner beneath another object, such as a target, being simultaneously supported by the stand.

FIG. 15 depicts a perspective view of a target being supported in a downwardly depending position from the stand.

FIG. 16 depicts a perspective view of a target being supported in an upwardly projecting position from the stand.

FIG. 17 depicts a perspective view of the target depicted in FIG. 15 and demonstrates one manner in which the target may be rotated about an axis while otherwise maintaining the target's position relative to the stand.

FIG. 18 depicts a front elevation view of one manner in which the stand may be used to support a target in a generally vertical fashion.

FIG. 19 depicts a perspective view of the stand and demonstrates one manner in which a pair of targets may be supported by the stand in a vertically spaced apart relationship with one another.

FIG. 20 depicts a perspective view of the stand and demonstrates another manner in which a pair of targets may be supported by the stand in a vertically spaced apart relationship with one another.

FIG. 21 depicts a side elevation view of the stand in a partially collapse position.

FIG. 22 depicts a front elevation view of one embodiment of attachment connectors that may be used with the stand, with its stabilizer members in a collapsed position.

FIG. 23 depicts a rear elevation view of the attachment connectors depicted in FIG. 18.

FIG. 24 depicts a front elevation view of another embodiment of a net support and net that may be supported by the stand.

FIG. 25 depicts a rear isometric view of the net support and net depicted in FIG. 23.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

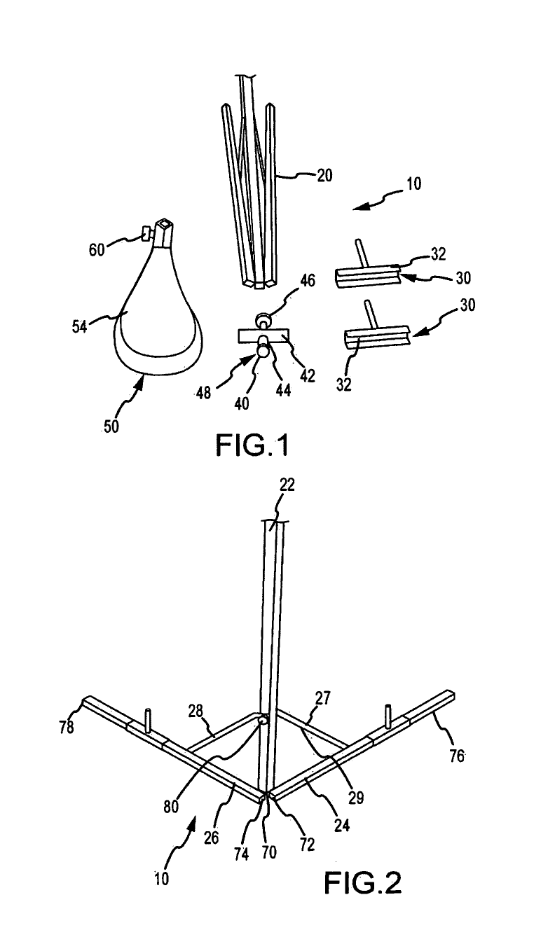

With reference to FIG. 1 and according to one contemplated embodiment of a stand 10 includes a collapsible base portion 20, weight mounts 30, connector 40, target 50, and impact sensing module 60.

The base portion 20, shown in a collapsed state in FIG. 1 and an expanded state in FIG. 2, includes an elongate central member 22 and elongate stabilizer members 24, 26. The stabilizer members 24, 26 are pivotally coupled to a bottom end portion 70 of the central member 22 at first end portions 72, 74, respectively, such that the stabilizer members can pivot about their first end portions relative to the central member. Connector arms 27, 28 having first end portions that are pivotally coupled to the stabilizer members 24, 26, respectively, at locations intermediate the first end portions 72, 74 and second end portions 76, 78 of the respective stabilizer members.

Although the illustrated embodiments show two stabilizer members, in other embodiments, more than two stabilizer members can be used. Also, when the stabilizer members are in an expanded position, in some embodiments, the stabilizer members can form angles other than 90-degrees relative to each other.

Second end portions of the connector arms 27, 28 are coupled to the central member 22 via a movable bracket 29. The movable bracket 29 extends about the central member 22 and is movable along the central member. The movable bracket 29 includes a locking mechanism that is engageable with the central member 22 to lock the movable bracket in place relative to the central member. In the illustrated embodiments, the lock member includes a spring-loaded pin sized to extend through spaced-apart apertures in the central member 22. The pin is coupled to a tightening knob 80 that can be tightened to secure the pin within the aperture and place the bracket 29 a locked state. The knob can be loosened and pulled outwardly to retract the pin out of engagement with the aperture of the central member 22 to place the bracket 29 in an unlocked state and allow the bracket to move relative to the central member 22.

The connector arms 27, 28 are pivotally coupled to the bracket 29 such that as the movable bracket is moved relative to the central member 22 the second end portions of the connector arms 27, 28 pivot relative to the bracket and move linearly along the central member. Such movement causes the first end portions of the connector arms 27, 28 to pivot relative to the stabilizer members 24, 26 such that the stabilizer members pivot about their first end portions 72, 74 toward the central member 22 as the bracket 29 moves away from the bottom end portion 70 and away from the central member as the bracket moves toward the bottom end portion.

With reference to FIG. 2, the base portion 20 may be placed in an open, or expanded, state by locking the bracket 29, i.e., inserting the pin into an aperture and tightening the knob 80, at a location along the central member 22 such that the stabilizer members 24, 26 extend generally perpendicularly relative to the central member and each other. In other words, with the base portion 20 positioned on a horizontal surface parallel to ground, the stabilizer members 24, 26 extend parallel to ground and the central member 22 extend vertically, or perpendicular to ground.

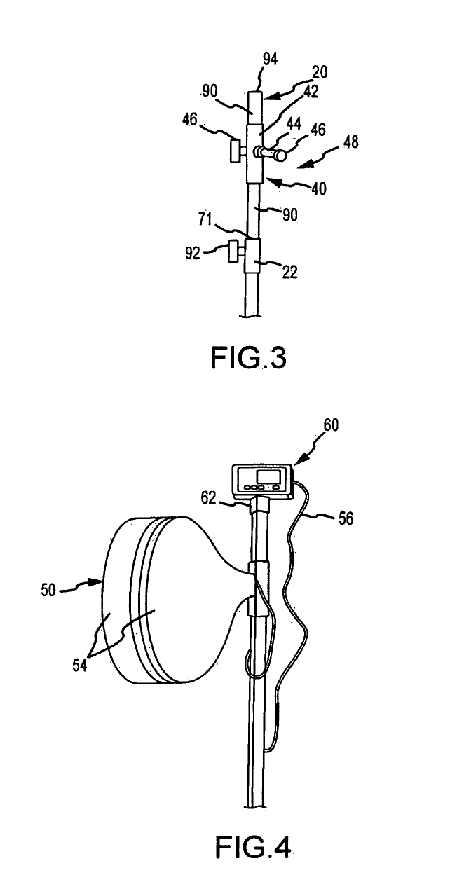

With reference to FIG. 3, the base portion 20 may also include a height adjustment member 90 that is movable relative to the central member 22. Although not necessary, in certain implementations, the height adjustment member 90 is aligned with the central member 22 and extends vertically away from the central member. In at least one embodiment, the central member 22 may be provided in the form of a tubular member that defines an interior channel through which the height adjustment member 90 may extend. In this manner, the height adjustment member 90 can extend linearly away from or toward the central member 22 in a telescoping manner to increase or decrease the overall height of the base portion 20.

The central member 22 may be provided to include a locking mechanism proximate its upper end portion 71. In at least one embodiment, similar to the locking mechanism of bracket 29, the locking mechanism of the central member 22 may be provided to include a spring-loaded pin that is sized to extend through spaced-apart apertures in the central member 22. The locking mechanism of the central member 22 may include a knob 92 coupled to the pin to facilitate locking and unlocking the height adjustment member 90 relative to the central member 22.

In some embodiments, the stand does not include a height adjustment member and the connector is coupled directly to and adjustably relative to the central member. Further, in some embodiments, the height adjustment member can be adjustably positioned using conventional bracketing techniques to extend at an angle relative to the central member.

In certain embodiments, the stand 10 includes weight mounts 30 that each have a generally U-shaped base 32 defining a channel for receiving a respective stabilizer member 24, 26. An elongate weight securing member 34 may be provided to extend from the base 32. The weight mounts 30 can be removably positioned about the stabilizer members such that the weight securing members 34 extend transversely relative to the stabilizer members in a vertical direction. The weight securing members are configured to receive one or more conventional gymnasium weight disks, which act as anchors to keep the stand 10 in place during use. When the stand 10 is to be stored or repositioned, the weight disks can be removed. The stand 10 in some implementations weighs approximately 20 lbs. and can be easily stored or moved.

The weight mounts 30 may be positioned about the stabilizer members at any of a plurality of locations between the first end portions 72, 74 and second end portions 76, 78 of the respective stabilizer members 24, 26. Accordingly, the weight can be adjustably distributed along the stabilizer members 24, 26 based on the particular sporting activity desired. Further, as described above, the weight mounts can include one or more various locking mechanisms (not depicted) to lock the mounts in place relative to the stabilizer members 24, 26.

With reference to FIGS. 1 and 3, the connector 40 may be provided to include a base portion 42 and an accessory receiving portion 44 extending from the base portion 42. In the illustrated embodiments, the base portion 42 includes a generally tubular member that defines a conduit through which the height adjustment member 90 may extend. The base portion 42 includes a locking and tightening mechanism 43 that has a spring-loaded pin and an associated knob 46. The pin is engageable with the apertures formed in the height adjustment member 90 and the knob 46 can be rotated to lock the connector 40 in place relative to the height adjustment member. The connector 40 can be locked in place relative to the height adjustment member 90 at any of various locations along the adjustment member.

In the illustrated embodiments, the accessory receiving portion 44 is a generally tubular member extending substantially perpendicularly from the base portion. The accessory receiving portion 44 defines an interior channel that may be sized to receive a portion of an accessory, such as target 50. The accessory receiving portion 44 can include a slot that extends from an open end 46, opposite the base portion 42, and a clamp mechanism 48 that extends about the accessory receiving portion proximate the open end. The cross-sectional area of the channel can be reduced by tightening the clamp mechanism 48 into a locked position which reduces the width of the slot. In some implementations, the clamp mechanism 48 is a conventional quick release clamp.

In the illustrated embodiments, the central member 22, stabilizer members 24, 26, height adjustment member 90, and base portion 42 of the connector 40 are generally square-shaped tubular members. In other embodiments, these features can tubular members having other shapes, such as generally circular, elliptical, triangular, or rectangular. Moreover, in some implementations, one or more of the components of the stand 10 are made of metal, such as an aluminum or steel alloy, and in other implementations, one or more of the components are made of plastic or other rigid or at least partially rigid material.

Generally, the accessory has an attachment member, such as attachment member 52 of target 50, having the same general cross-sectional shape as the channel of the accessory receiving portion 44 and a cross-sectional area that is slightly smaller than the same channel. The attachment member of the accessory may be inserted into the channel of the accessory receiving portion 44 when the clamp mechanism 48 is in an unlocked position. With the attachment member of the accessory positioned within the channel and the clamp mechanism in an unlocked state, the accessory can be rotated 360-degrees relative to the accessory receiving portion 44. Accordingly, the accessory can be positioned at any desired angle relative to the ground. Once the accessory is in a desired angle, the clamp mechanism 48 can be tightened to secure the accessory to the accessory receiving portion 44. Similarly, the clamp can be loosened to remove the accessory or reposition the accessory to a different angle. In one aspect a spring 53 may be associated with the attachment member 52 and disposed between the target 50 and the accessory receiving portion 44. In this manner a measured, multi-axis resiliency is provided to the connection of the target 50 to the stand 10 that allows the target 50 to be struck by a user while permitting the target 50 to return to its original position.

In some implementations, an additional connector can be secured to the accessory receiving portion 44 of the universal connector 40 and the accessory can be secured to the additional connector. In these implementations, the additional connector can rotate about an axis of the accessory receiving portion 44 and the accessory can rotate about the additional connector on an axis perpendicular to the axis of the accessory receiving portion 44 to provide an additional degree of adjustability.

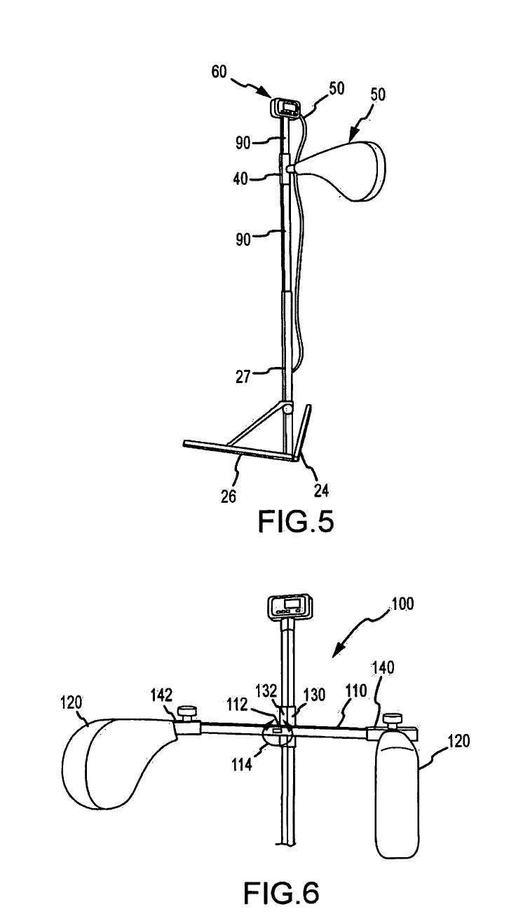

With reference to FIGS. 1, 4 and 5, the target 50, or hitting pad, may be provided to include a padded striking surface 54 on opposing sides of an at least partially rigid frame. The target may further include an impact sensor (not shown), such as described in U.S. Pat. No. 7,308,818, which is incorporated herein by reference. The impact sensor can be secured to the frame such that it is covered by the padded striking surface. The impact sensor is electrically coupled to an electrical connector, such as wire 56. In some implementations, the accessory includes a second wire electrically coupled to the impact sensor of the accessory at one end and electrically coupleable to an impact sensor of another accessory such that the accessories are electrically linked with one another.

In at least one embodiment, the wire 56 is coupled to the impact sensor on one end and electrically coupled to impact-sensing module 60 at an opposite end. As shown in FIG. 4, the impact sensing module 60 may include a mount 62 that is sized to receive an upper end 94 of the height adjustment member 90. In this manner, if desired, the impact-sensing module 60 can be mounted to the stand 10 for enhanced convenience and ease in viewing. In some implementations, the impact-sensing module 60 is an impact-sensor module as described in U.S. Pat. No. 7,308,818. In other implementations, the module can be any of various other types of impact-sensing computers or devices.

Although the stand system 10 described above includes an impact sensor and an impact-sensing module, in some embodiments, the stand system does not include an impact sensor or impact-sensing module. In these implementations, the stand system can be used in the same or a similar manner as a stand system having an impact sensor and module, except that detection and feedback of impacts is not provided. Alternatively, if desired, the impact-sensing module can be turned off and the user can engage in a workout without such functionality.

With reference to FIG. 6, according to another embodiment, a stand 100 may be provided to include an accessory extension member 110. The stand 100 is similar to stand 10 except that instead of having a single target, stand 100 include two targets 120 removably and adjustably coupled to an accessory extension member 110. The accessory extension member 110 may be provided to include an attachment member 112 that is removably securable within an accessory receiving portion 132 of a primary connector 130 in a manner similar to that described above in relation to attachment member 52 and accessory receiving portion 44 of stand 10. In some embodiments, the extension member 110 may be provided to rotate about the accessory receiving portion 360-degrees, as indicated by arrow 114, to place the extension member in any of various positions depending on the particular application. For example, as shown in FIG. 6, the extension member 110 may be positioned to extend generally parallel to horizontal. If desired, the extension member 110 may also be provided to rotate 180-degrees into a vertical orientation and lock in place using the locking mechanism of the connector 130.

The stand 100 may further include first and second secondary connectors 140, 142 removably and adjustably coupleable to the accessory extension member 110. The first and second secondary connectors 140, 142 may be removably securable to the extension member 110 via locking mechanisms as described above and positionable at any of various locations along the extension member. Each target 120 may be provided to be removably securable to a respective one of the first and second secondary connectors 140, 142. Each target 120 may also be provided in a manner that permits each target 120 to be rotated to a particular angle irrespective of the angle of the other target.

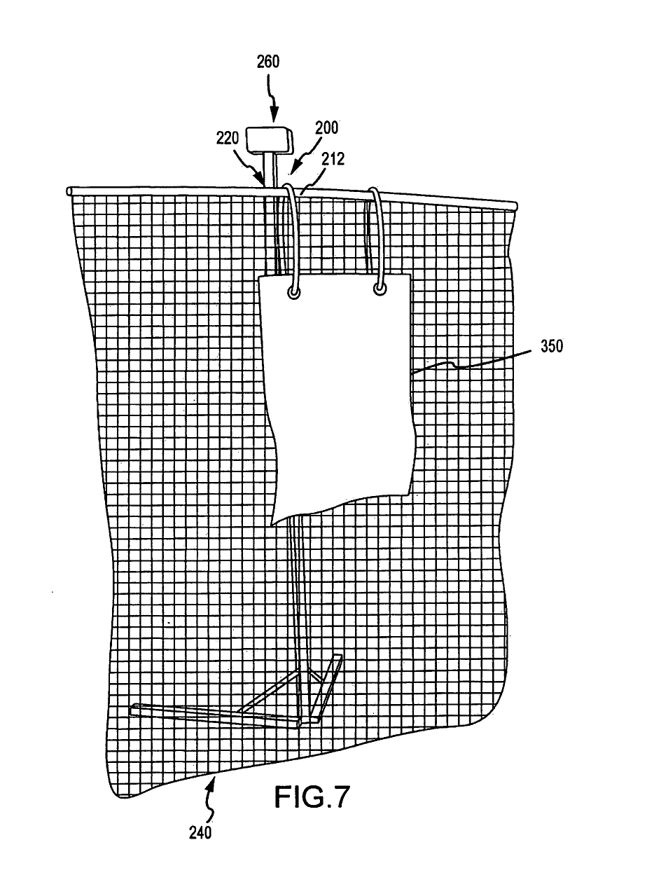

With reference to FIG. 7, and according to at least one embodiment, a stand 200 may be provided that is similar to stand 10 except that target 50 is replaced with a different accessory, such as a net accessory 210. The net accessory 210 may be provided to include an attachment member 212 that is removably securable to a connector 220 similar to connector 40. A net hanger 230 may be provided to be coupled with the attachment member 212 and a net 240 may be secured to and depend from the net hanger 230. The net accessory 210 may also include an impact surface 350, such as a pad, to which an impact sensor (not shown) is secured. The impact sensor may be electrically coupled to an impact sensing module, such as impact-sensing module 260.

The impact sensor is configured to detect impacts delivered to the impact surface 350 by any of various objects. For example, a user desiring to improve his or her golf game can hit golf balls into the impact surface 350 to determine ball flight speed. The net 240 may also be configured to capture the golf balls that fail to hit the impact surface 350. In other implementations, a user can use the net accessory to practice and receive feedback regarding other sporting activities, such as, for example, throwing a football, hitting a baseball, or kicking a soccer ball.

Although the accessories relate to a punching target and a net accessory, in other embodiments, any of various other sporting accessories can be connected to the connectors.

The stand as described herein provides multiple degrees of adjustability and is highly versatile. For example, the height of the targets 50 can be increased or decreased by raising or lowering the height adjustment member 90 relative to the central member 22 or raising or lowering the connector 40 relative to the height adjustment member. Also, in some embodiments, the stand includes multiple connectors and associated accessories. For example, the height adjustment member 90 can include multiple connectors 40 as opposed to a single connector as shown, and the accessory extension member 110 can include more than two connectors. Additionally, the accessories can be rotated 360-degrees to any of various orientations to accommodate any of various physical actions.

The stand is easily portable and storable. If used, the weights can be removed from the weight mounts and, if desired, the accessories can be removed from the connectors. The locking mechanism of the movable bracket coupled to the central member can be loosened and the stabilizing member can be retracted upwardly inwardly toward the central member into a compact position, substantially parallel to the central member, similar to that depicted in FIG. 1.

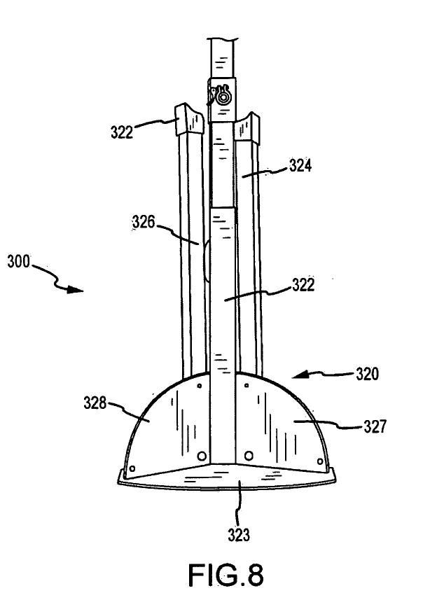

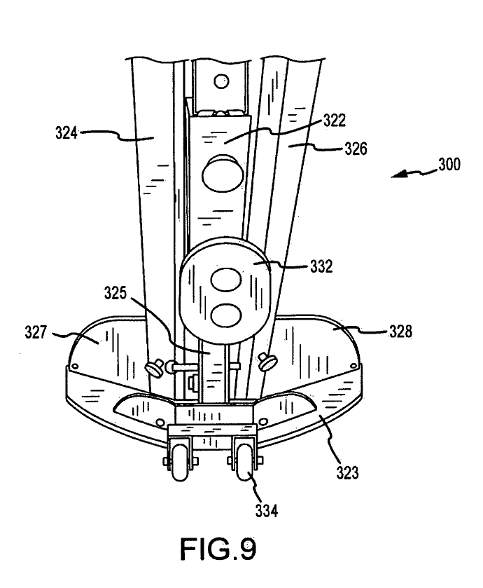

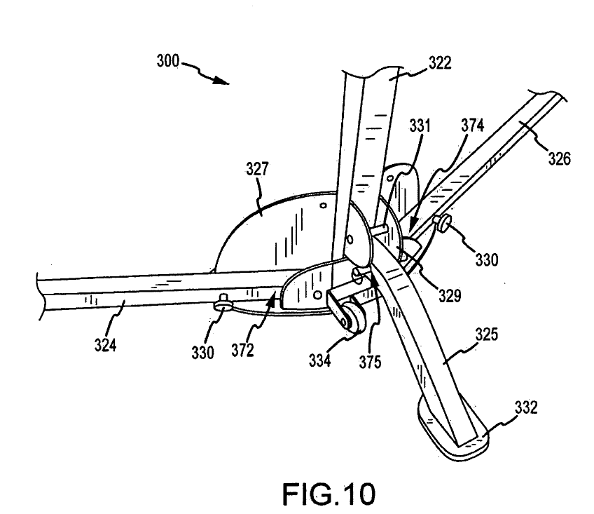

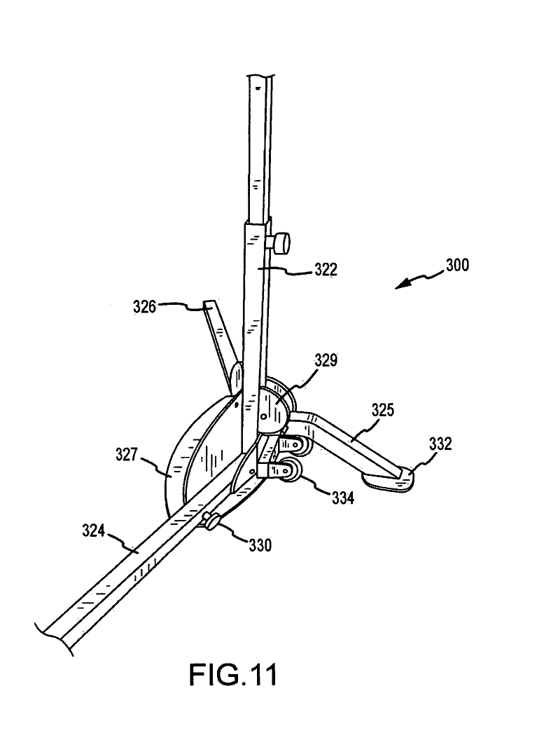

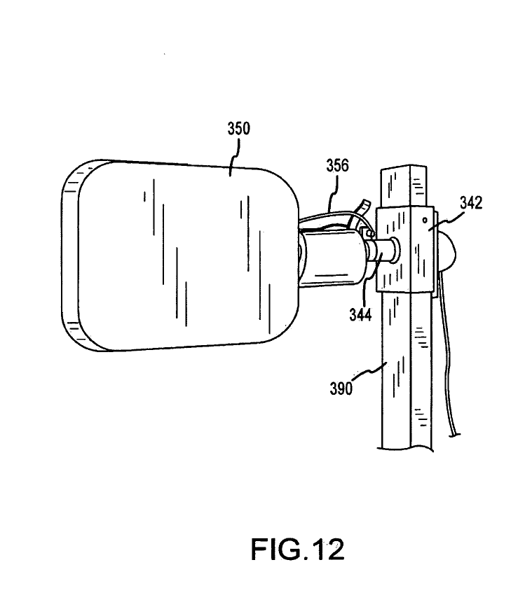

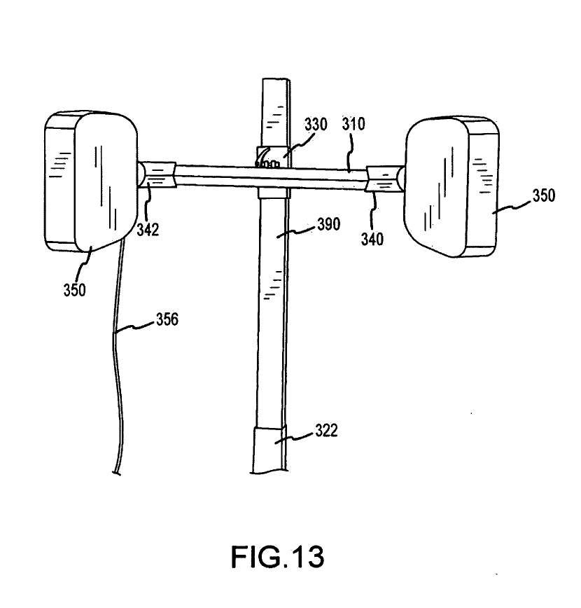

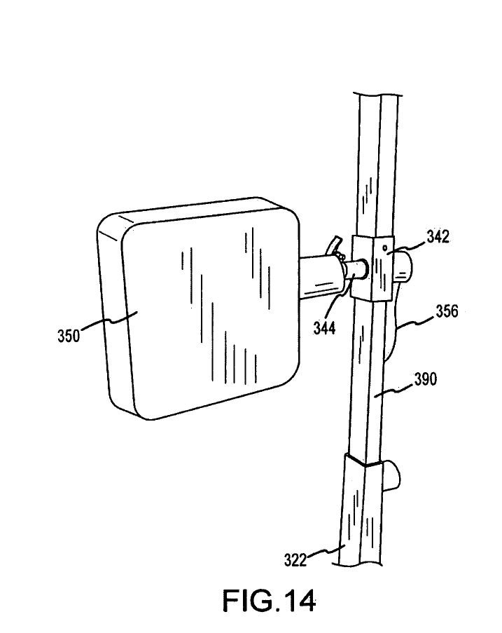

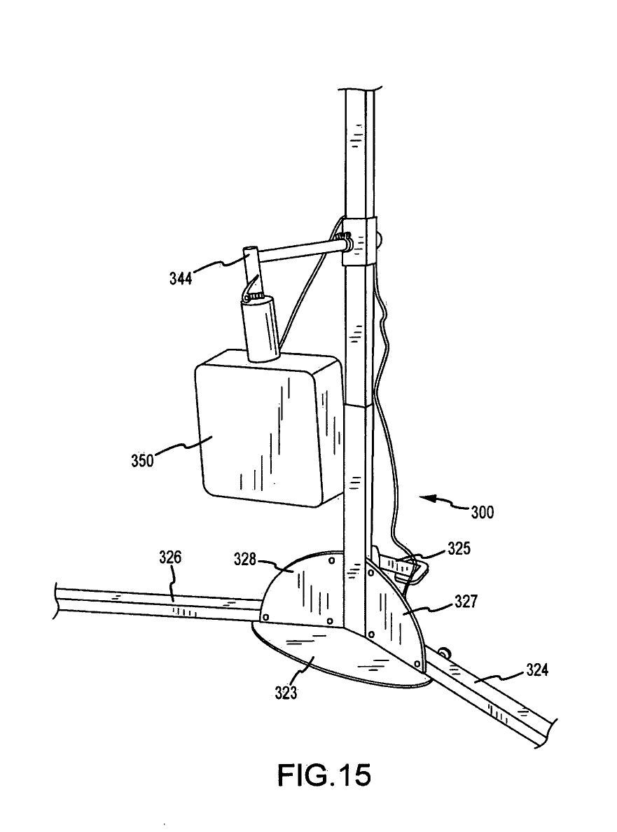

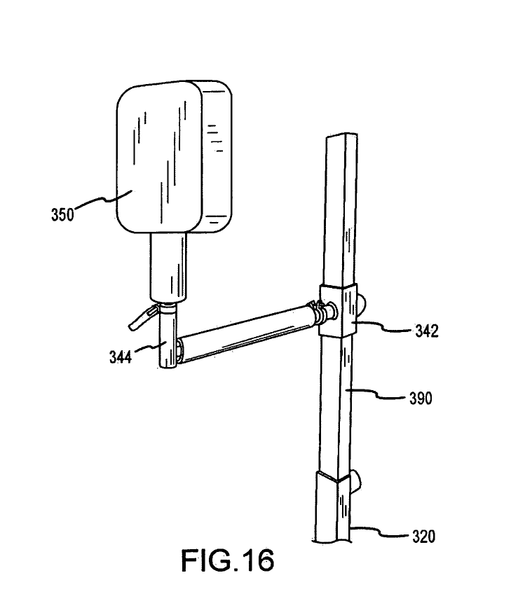

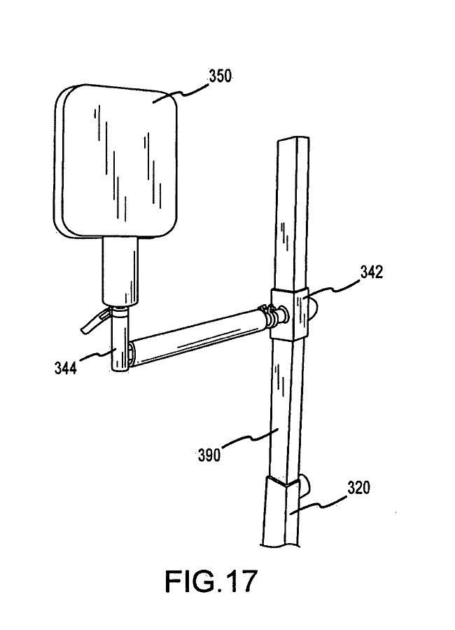

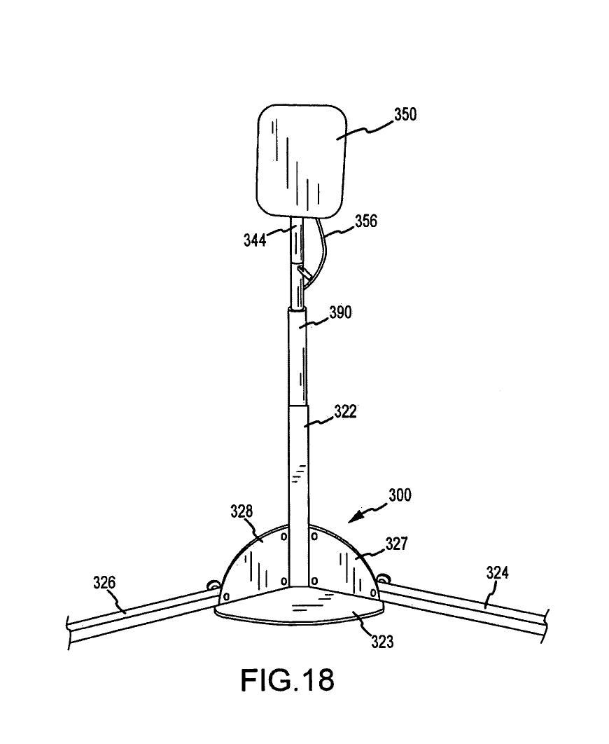

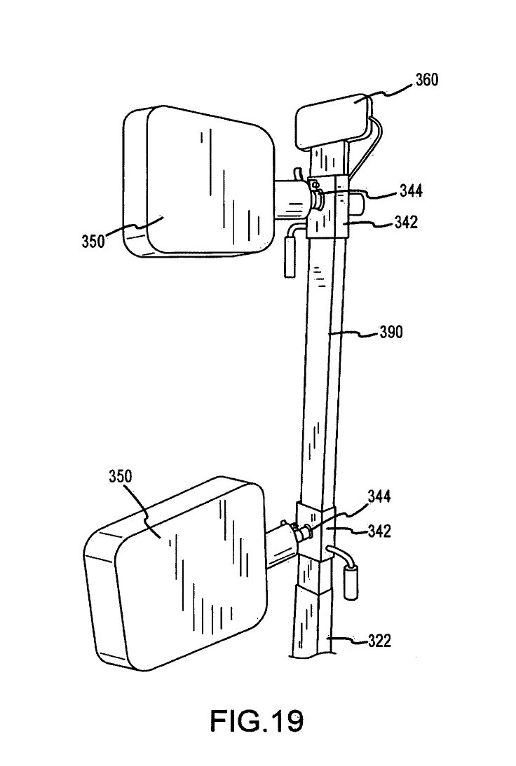

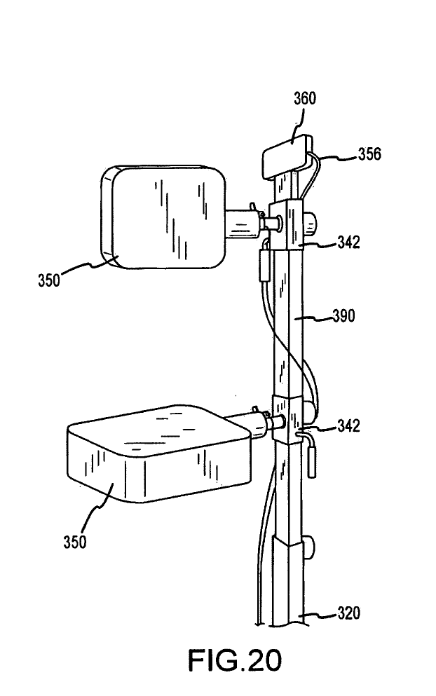

With reference to FIGS. 8 and 9, according to another embodiment, a stand 300 may be provided in a heavier and more durable fashion for commercial applications and sports uses. The base portion 320, shown in a collapsed state in FIGS. 8 and 9 and an expanded state in FIGS. 10 and 11, includes an elongate central member 322 and elongate stabilizer members 324, 326. Connector plates 327, 328 are coupled to a bottom end portion 370 of the central member 322 and a base plate 323 along side and bottom edge portions of the connector plates 327, 328. The stabilizer members 324, 326 are coupled to the connector plates 327, 328 at first end portions 372, 374, respectively, such that the stabilizer members can pivot about their first end portions relative to the central member 322. Spring-loaded pins 330 may be associated with the stabilizer members 324, 326 that are sized to extend through apertures formed adjacent upper and lower end portions of the connector plates 327, 328. In this manner, the stabilizer members 324, 326 may be secured in their respective collapsed and expanded states.

An additional stabilizer member 327 may be associated with the stand 300 in a spaced-apart relationship with the stabilizer members 324, 326. In one aspect, a connector bracket 329 may be coupled with the central member 322. A first end portion 375 of the stabilizer member 327 may be pivotally coupled with the connector bracket 329 to permit the stabilizer member to move between collapsed and extended states. A retaining pin 331 may be engaged with apertures formed adjacent upper and lower end portions of the connector plates 329 to secure the stabilizer member 327 in its respective collapsed and expanded states. While the spring-loaded pins 330 are depicted as being associated with the stabilizer members 324, 326 and the retaining pin 331 is depicted as being associated with the stabilizer member 327, it is contemplated that each of the stabilizer members 324, 326, 327 could be provided with a similar locking mechanism. To that end, other locking mechanisms known in the art may be employed in their stead.

In certain embodiments, the stabilizer members 324, 326, 327 of the stand 300 may be weighted to promote stability of the stand 300 when it is use. In some embodiments the stabilizer members 324, 326, 327 may be provided with open interior portions that are filled with one of various materials to add a desired amount of weight to the stand 300. In one aspect, the weight is provided by solid weight inserts. It is contemplated that the number and size of weights can be varied in order to accommodate the stability needs presented.

In one aspect, the stability of the stand 300 may be further promoted by engaging relatively high friction pads 332 at the distal end portions of the stabilizer members 324, 326, 327. It is contemplated that the high friction pads may be provided in the form of foot members formed from various materials, including generally resilient materials that include natural and synthetic rubbers as well as some polymer materials. An additional friction pad 320 may be placed on a bottom surface of the base plate 323 for additional stability. The friction pads will further limit the transmission of vibrations from the stand 300 to the operating surface, which will tend to reduce noise emitted from use of the stand 300, and may further limit damage to the operating surface.

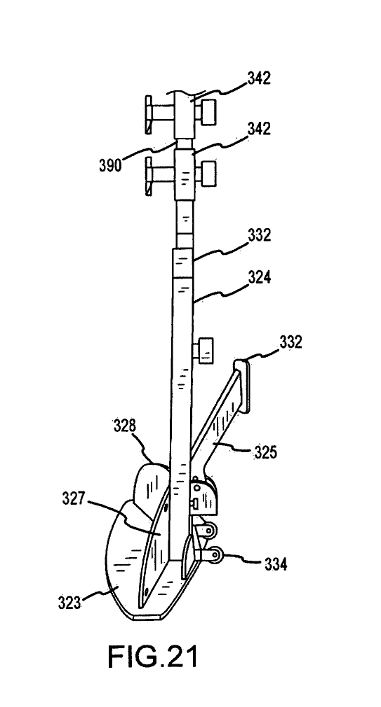

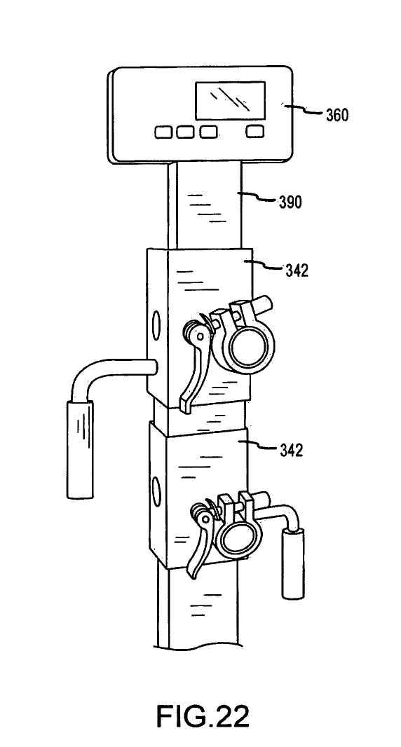

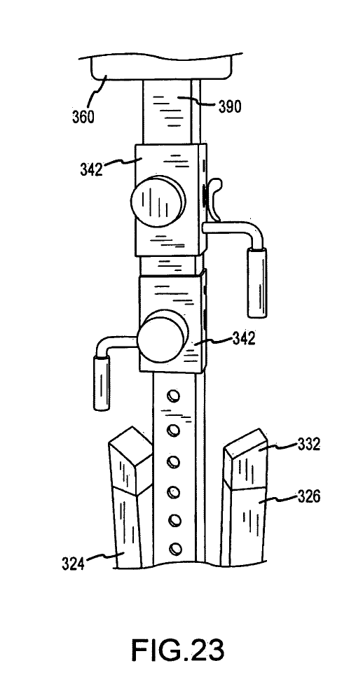

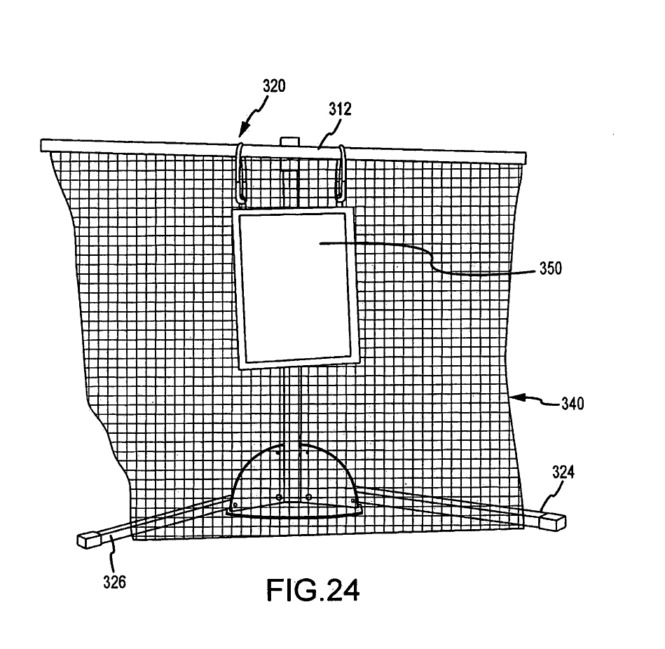

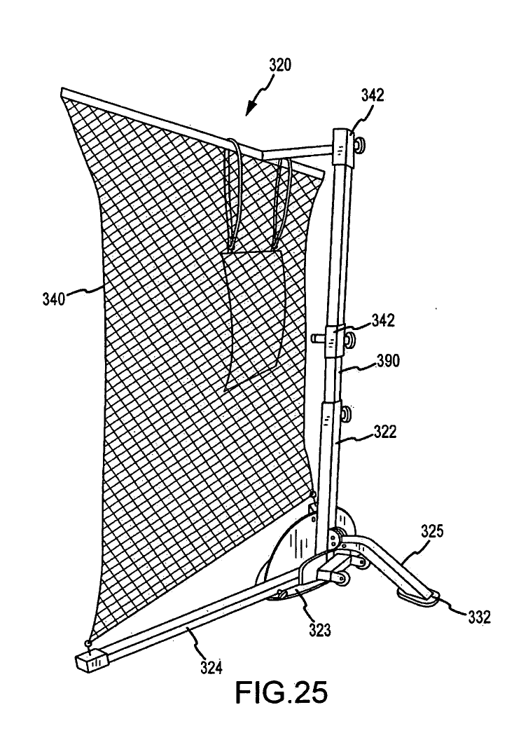

In at least one aspect, and with reference to FIGS. 21-23, the stand 300 may be provided with one or more wheels 334, positioned adjacent the base 320. In this manner, the stabilizer members 324, 326, 327 may be placed in their collapsed positions and the stand 300 may be tipped back onto the wheels 334 to enable a user to easily move the stand form one location to another.

Although the above embodiments of the sports stand have been described in relation to sporting activities, the sports stand can also be used for use with non-sporting activities. For example, in some embodiments, the sports stand can be used to support various objects, such as lights, audio speakers, sunshades, wind protection objects, signs, etc.

In another aspect, rather than spring-loaded pin and knob arrangements as described above, in some embodiments, the adjustability and securing of the height adjustment member relative to the central member, and the connector to the height adjustment member or extension member, can be accomplished using a split sleeve and clamp arrangement or other pin-style arrangement.

Although the system has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

What is claimed is:

1. A system for supporting one or more objects above an operating surface, the system comprising:
a central frame member having opposite first and second end portions;
a base operatively coupled with the first end portion of said central frame member; said base being selectively movable between collapsed and extended positions with respect to said frame;
at least one attachment member operatively coupled with the central frame member; and
at least one object operatively coupled with the attachment member for supporting the one or more objects above the operating surface.

2. The system of claim 1 wherein said base is comprised of a plurality of stabilizer members having opposite first and second end portions; the first end portions being operatively, pivotably coupled with the first end portion of said central frame member.

3. The system of claim 1 further comprising:
a bracket operatively coupled with said central frame member and selectively movable along a length of said central frame member between the opposite first and second end portions of said central frame member; and
one or more connector arms, having first and second opposite end portions; the first end portion of said one or more connector arms being pivotably coupled with said base; the second end portion of said one or more connector arms being pivotably coupled with said bracket.

4. The system of claim 3 further comprising:
a locking mechanism that selectively secures a relative position between said bracket and said central frame member.

5. The system of claim 4 wherein said locking mechanism includes a spring-biased pin that is operatively coupled with said bracket and sized and shaped to extend through one or more apertures formed along a length of said central frame member.

6. The system of claim 5 wherein said locking mechanism further includes a tightening knob that is operatively coupled with said pin so that said tightening knob may be selectively tightened to secure said pin in a position within one of said one or more apertures in said central frame member.

7. The system of claim 4 wherein said base is comprised of a plurality of stabilizer members having opposite first and second end portions; the first end portions being operatively, pivotably coupled with the first end portion of said central frame member.

8. The system of claim 1 wherein said at least one attachment member is slidably coupled with the central frame member so that said at least one attachment member may be selectively positioned along a length of said central frame member

9. The system of claim 1 wherein said at least one attachment member is comprised of a spring that enables said at least one attachment member to provide a resiliently deformable engagement between the one or more objects and the central frame member.

10. The system of claim 1 wherein said base is comprised of a plurality of stabilizer members having opposite first and second end portions; the first end portions being operatively, pivotably coupled with connector brackets that are operatively coupled with said central frame member.

11. The system of claim 10 wherein at least one of said stabilizer members is provided with an open interior portion that houses one or more weights.

12. The system of claim 1 further comprising:
a locking mechanism that selectively secures a relative position between said stabilizer members and said central frame member.

13. The system of claim 12 wherein said locking mechanism includes a pin that is operatively coupled with each of said stabilizing members and sized and shaped to extend through one or more apertures formed through each of said connector brackets.

14. The system of claim 1 further comprising:
one or more wheels associated with said base to enable transport of the system from one location to another

15. The system of claim 1 wherein said at least one attachment member is provided with a joint that permits the attachment member to support the one or more objects at a selectively variable position with respect to the central frame member.

16. The system of claim 1 wherein said at least one attachment member is provided with an elongated attachment frame having a plurality of attachment points to simultaneously support a plurality of objects.

17. The system of claim 16 wherein said attachment points may be selectively varied in position along a length of said attachment member.

18. The system of claim 1 wherein the one or more objects supported by the system are targets that arc adapted to receive a striking force from an external source.

19. The system of claim 19 further comprising:
means for quantifying said striking force as it is received by said targets.

20. The system of claim 1 wherein the one or more objects supported by the system includes a net support and a net that at least partially depends from said net support.

21. The system of claim 20 wherein the one or more objects supported by the system further include at least one target, positioned adjacent said net, that is adapted to receive a striking force from an external source.

22. The system of claim 21 further comprising:
means associated with said target for quantifying said striking force as it is received by said targets.
